(19) United States
(12) Patent Application Publication
(10) Pub. No.: US 2016/0097221 A1
(43) Pub. Date: Apr. 7, 2016

(54) Restraint Device for Use in Vehicles

(71) Applicant: Mark Delk, Burlison, TN (US)

(72) Inventor: Mark Delk, Burlison, TN (US)

(21) Appl. No.: 14/818,649

(22) Filed: Aug. 5, 2015

Related U.S. Application Data
(60) Provisional application No. 62/058,145, filed on Oct. 1, 2014.

(51) Int. Cl. E05B 75/00

(52) U.S. Cl. CPC E05B 75/00

(57) ABSTRACT

A restraint system for use in police vehicles. The restraint system includes an elongated bar that can be mounted in a horizontal orientation in an elevated position on the divider between the front interior of the vehicle and the rear interior of the vehicle. One or more chains are connected at a first end to the elongated bar and include a locking cuff on a second end thereof. In operation, the chain of a pair of handcuffs worn by a person being detained in the rear of the vehicle can be positioned within the locking cuff of the restraint system. This serves to further restrain the person being detained, and positions the person's hands in a raised position such that they are visible by the police officers within the front of the vehicle.

### CROSS REFERENCE TO RELATED APPLICATION

This application claims the benefit of U.S. Provisional Application No. 62/058,145 filed on Oct. 1, 2014. The above identified patent application is herein incorporated by reference in its entirety to provide continuity of disclosure.

### BACKGROUND OF THE INVENTION

### Field of the Invention

The present invention relates to restraint devices. More specifically, the present invention provides a restraint device for use in the rear of police vehicles for further restraining a person in handcuffs that allows police officers to view the position of the person's hands. The restraint device comprises an elongated bar having one or more chains extending therefrom, wherein the chains each include a locking cuff adapted to hold the chain of the person's handcuffs therein.

Police officers and other law enforcement personnel often have to transport suspected or convicted criminals, prisoners, and other persons, herein referred to simply as “prisoners.” Prisoners are often restrained using handcuffs so that the prisoners do not escape from police custody and so that they do not attempt to hurt the police officers. Further, the prisoners are closely monitored and are escorted by police officers so that the prisoners do not try to remove their handcuffs or otherwise escape.

During transportation, the prisoners are placed in the rear of the police vehicle and they are separated from the police officers in the front of the vehicle via a divider. While in the rear of the vehicle, the prisoners may attempt to break free from their restraints, and some prisoners may be able to slip one or both hands out of their handcuffs. The police officers may have difficulty monitoring the prisoner while driving the vehicle, and prisoners are often handcuffed such that their hands are behind their back. Thus, a device for restraining prisoners in the rear of a police vehicle that allows police officers to more easily view the prisoner's hands is desired.

Devices have been disclosed in the prior art that relate to restraint devices for prisoners. These include devices that have been patented and published in patent application publications. These devices generally relate to restraint devices for restraining a prisoner seated in a vehicle, such as U.S. Pat. No. 5,261,728, U.S. Pat. No. 4,789,183, U.S. Pat. No. 7,712,200, and U.S. Pat. No. 4,173,974.

These prior art devices have several known drawbacks. The devices in the prior art relate to prisoner restraint devices for use in vehicles, but fail to provide a device having an elongated bar that is securable to the divider or partition of a police vehicle wherein a chain having a locking cuff thereon is secured to the elongated bar. The devices in the prior art do not help to allow police officers to more easily view and monitor the prisoner's hands while seated in the rear of a police vehicle.

In light of the devices disclosed in the prior art, it is submitted that the present invention substantially diverges in design elements from the prior art and consequently it is clear that there is a need in the art for an improvement to existing restraint devices. In this regard the instant invention substantially fulfills these needs.

### SUMMARY OF THE INVENTION

In view of the foregoing disadvantages inherent in the known types of restraint devices now present in the prior art, the present invention provides a new restraint device wherein the same can be utilized for providing convenience for the user when transporting a prisoner in the rear of a police vehicle while allowing police officers to more easily monitor or view the prisoner's hands.

It is therefore an object of the present invention to provide a new and improved restraint device comprising an elongated bar securable to the divider of a police vehicle, wherein a chain is affixed at a first end to the elongated bar and includes a locking cuff on a second end thereof, such that the locking cuff can be secured around the chain on the handcuffs of a prisoner seated in the vehicle.

It is another object of the present invention to provide a restraint device comprising an elongated bar adapted to be mounted in a horizontal orientation in an elevated position on the divider between the front and rear of a police vehicle via any suitable fasteners.

Another object of the present invention is to provide a restraint device comprising a chain with a locking cuff thereon, wherein the prisoner's hands are positioned in front of the prisoner and in view of officers when the restraint device is in use.

Yet another object of the present invention is to provide a restraint device that can be used in conjunction with a conventional pair of handcuffs.

Another object of the present invention is to provide a restraint device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an embodiment of the restraint device.

FIG. 2 shows a close-up view of the locking cuff of the restraint device.

FIG. 3 shows a perspective view of the restraint device in use.

### DETAILED DESCRIPTION OF THE INVENTION

Reference is made herein to the attached drawings. Like reference numerals are used throughout the drawings to depict like or similar elements of the restraint device. For the purposes of presenting a brief and clear description of the present invention, the preferred embodiment will be discussed as used for restraining a prisoner in the rear of a police vehicle, wherein the restraint device positions the prisoner's hands in front of the prisoner such that they are easily viewed by an officer in the front of the vehicle. The figures are intended for representative purposes only and should not be considered to be limiting in any respect.

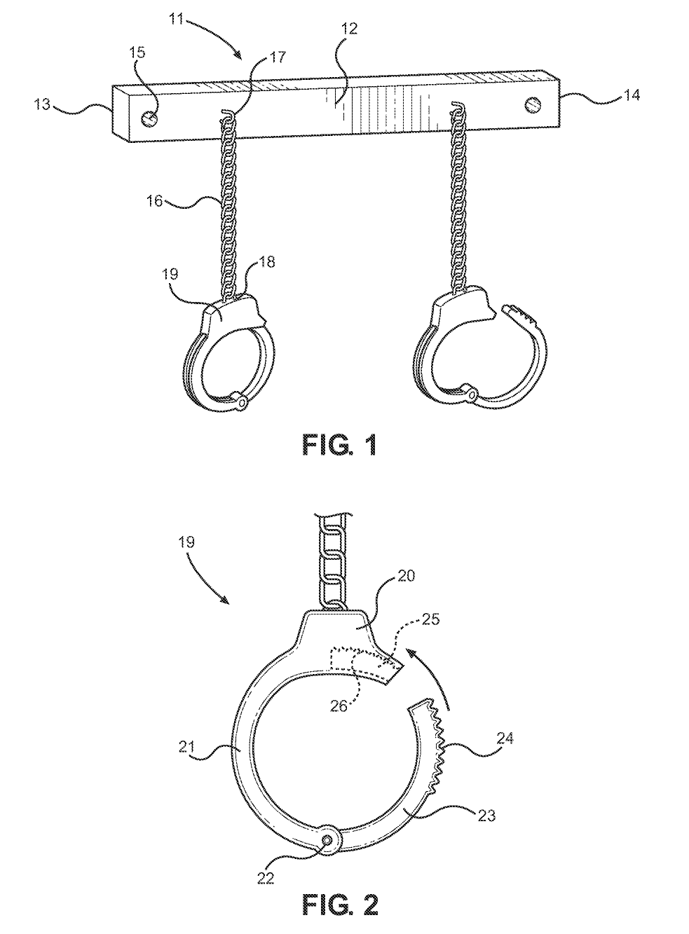

Referring now to FIG. 1, there is shown a front perspective view of an embodiment of the restraint device. The restraint device 11 comprises an elongated bar 12 having a first end 13 opposite a second end 14. The elongated bar 12 is flat so that it can be placed flush against a partition or divider of a police vehicle. The elongated bar 12 is adapted to be disposed in a horizontal orientation and in an elevated position. The elongated bar 12 further comprises one or more openings 15 therethrough, wherein fasteners, such as bolts, can be inserted through said openings 15 in order to secure the elongated bar 12 to a support surface. However, in alternate embodiments, the elongated bar 12 is secured to a support surface via adhesives, welding, or other similar fastening methods.

One or more chains 16 having a first end 17 and a second end 18 are permanently affixed to the elongated bar 12 at the first end 17 thereof. The chains 16 are preferably composed of a plurality of links so that the chains 16 are strong and durable yet movable. In the illustrated embodiment, the restraint device 11 comprises a pair of chains 16 such that a pair of prisoners can be simultaneously restrained in the rear of a police vehicle.

A locking cuff 19 is affixed to the second end 18 of each chain 16. The locking cuffs 19 are adapted to be fastened around the chain of a pair of handcuffs worn by a prisoner. In this way, the restraint device 11 can be used to restrain the movement of the prisoner and also helps to position the prisoner's hands in front of the prisoner and in an elevated position so that they can be easily viewed by the police officers in the front of the vehicle.

Referring now to FIG. 2, there is shown a close-up view of the locking cuff of the restraint device. The locking cuff 19 comprises a frame having an open central area through which the chain of a pair of handcuffs can be positioned. In the illustrated embodiment, the locking cuff 19 comprises a base portion 20 having a first arm 21 extending therefrom. The first arm 21 has an arcuate shape and defines a portion of the open central area. A second arm 23 is pivotally secured to the first arm 21 via a hinge 22 and can be moved between a closed configuration and an open configuration. In the closed configuration, the second arm 23 is inserted into a channel 25 on the base 20 so as to enclose the open central area. In the open configuration, the second arm 23 is removed from the base 20 so as to provide access to the open central area.

The second arm 23 further includes a plurality of ridges 24 thereon adapted to engage with ridges 26 disposed within the channel 25 on the base 20. The engagement of the ridges 24, 26 secures the second arm 23 in a desired position so that the locking cuff 19 cannot be reopened. The locking cuff 19 comprises a locking mechanism, and a key may be required in order to open the locking mechanism of the locking cuff 19 once the second arm 23 has been inserted into the channel 25 of the base 20. Further, the second arm 23 can be partially or completely inserted into the channel 25 so as to adjust the size of the open central area.

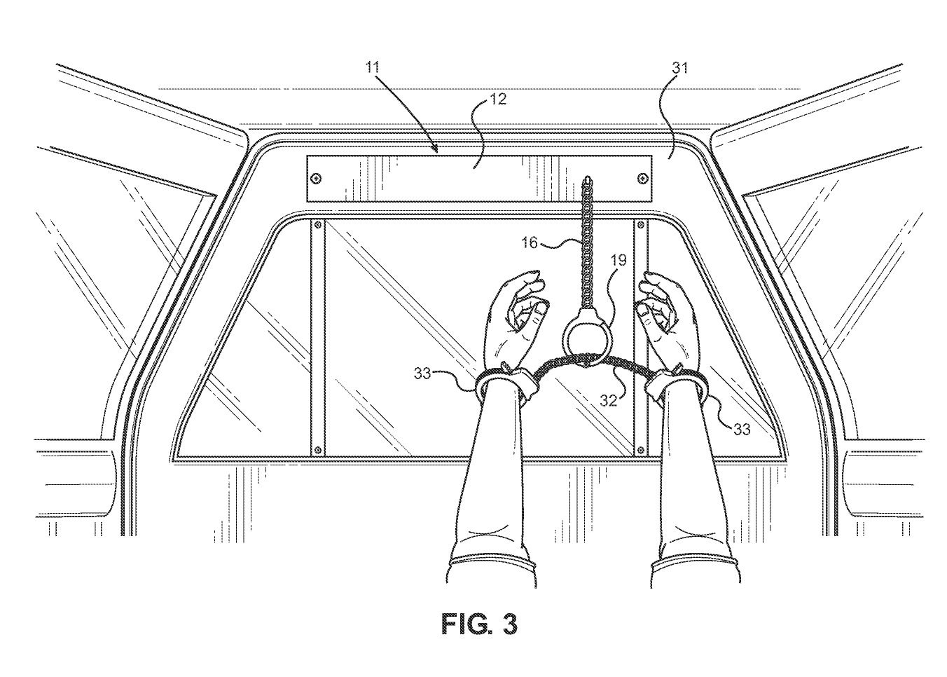

Referring now to FIG. 3, there is shown a perspective view of the restraint device in use. In operation, the elongated bar 12 of the restraint device 11 is adapted to be secured to the divider 31 or partition of a police vehicle. The elongated bar 12 can be affixed in a horizontal orientation in an elevated position via any suitable fastener or fastening method. The elongated bar 12 can be permanently installed on the divider 31 and can be integral therewith. The chain 16 extends downward from the elongated bar 12 and includes a locking cuff 19 on the end thereof.

A prisoner wearing a pair of handcuffs 33 can be positioned in the rear of the vehicle. The locking cuff 19 is secured around the chain 32 of the pair of handcuffs 33 so that the chain 32 passes through the open central area thereof. In this way, the prisoner is restrained by the engagement of the locking cuff 19 around the chain 32. Preferably, the chain 16 of the restraint device 11 is of sufficient length such that the prisoner's hands are positioned in an elevated position so that the police officers in the front of the vehicle can easily view and monitor the prisoner's hands so as to ensure the prisoner is not attempting to remove the handcuffs 33.

The police officers can unlock the locking cuff 19 using a key or other means for releasing the locking cuff 19 in order to allow the prisoner to be removed from the rear of the vehicle. In this way, the prisoner remains in handcuffs at all times so that the prisoner does not pose a threat to the police officers. Further, the restraint device 11 of the present invention is suitable for use with any type of conventional handcuffs.

In alternate embodiments, the elongated bar 12 comprises additional chains 16 each having a locking cuff 19 so that multiple prisoners can be restrained in the rear of the police vehicle. In this way, the police officers can more easily transport several prisoners at a time. The restraint device 11 also serves to prevent multiple prisoners from interfering with one another or hurting one another while seated in the rear of the vehicle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A restraint device, comprising:
an elongated bar adapted to be mounted to a support surface;
at least one chain having a first end and a second end;
said first end affixed to said elongated bar;
a locking cuff affixed to said second end, wherein said locking cuff comprises an open central area through which a chain of a pair of handcuffs can be positioned, wherein said locking cuff is movable between an open configuration and a closed configuration.

2. The restraint device of claim 1, wherein said elongated bar is rectangular in configuration.

3. The restraint device of claim 1, wherein said elongated bar comprises one or more openings thereon through which one or more fasteners can be inserted so as to secure said elongated bar to said support surface.

4. The restraint device of claim 1, wherein said chain is composed of a plurality of links.

5. The restraint device of claim 1, wherein
said locking cuff comprises a base having a first arm extending therefrom and a channel;
a second arm pivotally affixed to said first arm, wherein said second arm is removably inserted into said channel.

6. The restraint device of claim 1, wherein said locking cuff comprises a locking mechanism that allows said locking cuff to be secured in a closed configuration.
